(19) United States
(12) Patent Application Publication
(10) Pub. No.: US 2008/0037977 A1
(43) Pub. Date: Feb. 14, 2008

(54) Focusing method of image capturing device

(75) Inventor: Fan Wei Li, Taipei (TW)

Correspondence Address: TROXELL LAW OFFICE PLLC, SUITE 1404, 5205 LEESBURG PIKE, FALLS CHURCH, VA, 22041, US

(73) Assignee: Premier Image Technology Corp.

(21) Appl. No.: 11/502,492

(22) Filed: Aug. 11, 2006

(51) Int. Cl. G03B 13/00

(52) U.S. Cl. 396/127

(57) ABSTRACT

A focusing method for an image capturing device is disclosed. In the focusing method, a focus lens shifts step by step from the current position toward a selected direction, and generates a corresponding contrast value for each position. If the generated contrast values show an increasing trend, the focus lens continually shifts toward the selected direction; if a decreasing trend, then turns toward an opposite direction. In this way, an optimal position with the maximum contrast value can be found. An advantage of the focusing method is that the optimal position can be found quickly when it is not far away from the current position of the focus lens, thereby saving the focusing time.

### BACKGROUND OF INVENTION

1. Field of the Invention

The present invention relates to image capturing, and more particularly to a focusing method of an image capturing device.

2. Description of the Prior Art

When a conventional digital camera (or digital camcorder) performs focusing, a stepping motor is used to move a focus lens back and forth within a zoom lens of the camera (the moving distance is represented by one number of steps), and the light penetrating the focus lens is received by means of a light sensor (e.g. CCD). Then, a digital signal processor (DSP) is used to calculate the contrast value corresponding to each different position of the focus lens. FIG. 1 is a diagram showing a typical correspondence between the focus step number and the contrast value when the digital camera performs focusing. The horizontal axis of FIG. 1 is the focus step number that can represent the position where the focus lens is located. The values of the focus step number are measured against a reference position (the origin of FIG. 1). The vertical axis of FIG. 1 is the contrast value, which is calculated according to the contrast by the DSP. In FIG. 1, the correspondence is shown as a curve with a peak value. In an ordinary situation, the peak value of the curve is a maximal contrast value, and the value of the horizontal axis corresponding to this maximal contrast value is an optimal focus step number (at this time, the focus lens is located at an optimal position). The digital camera should retain the best resolution when shooting at the optimal focus step number.

However, when the conventional digital camera starts focusing, the focus lens, regardless where its current position is, is first shifted to the position corresponding to focusing at a far end (i.e. infinity) and then moved stepwise towards the position corresponding to focusing at a near end, thereby finding the position with the maximal contrast value. The deficiency of such approach is that if the camera is to focus at or close to the near end, it will take the camera longer to focus and thus degrade its performance, since the focus lens has to move a longer distance and gather more data (the data processing time is longer as well).

### SUMMARY OF INVENTION

It is therefore an objective of the present invention to provide a focusing method for an image capturing device (e.g. digital camera or digital camcorder) that effectively shortens the focusing time, thereby enhancing the performance of the image capturing device.

According to one embodiment of this invention, the focusing method for the image capturing device comprises steps of: (a) setting a focus lens of the image capturing device at an initial position and producing a contrast value corresponding to said initial position; (b) moving the focus lens to a next position; (c) producing a contrast value corresponding to said next position; (d) determining to move the focus lens either in a same direction as step (b) or in a reverse direction according to the contrast values already produced; (e) repeating steps (b) to (d) to produce a maximal contrast value; and (f) setting the focus lens at a position corresponding to the maximal contrast value.

### BRIEF DESCRIPTION OF THE DRAWINGS

The details of the present invention will be more readily understood from a detailed description of the preferred embodiments taken in conjunction with the following figures.

FIG. 1 is a diagram showing a typical correspondence between the focus step number and the contrast value when the digital camera performs focusing.

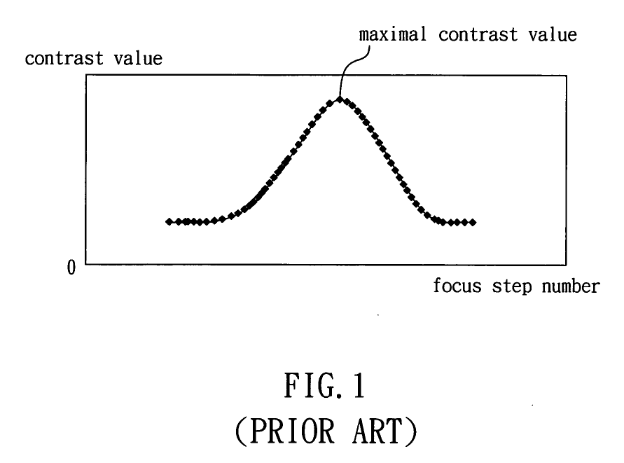

FIG. 2 is a flow chart of a preferred embodiment of the focusing method of this invention.

FIG. 3 is a diagram showing that the contrast values exhibit small volatility.

### DETAILED DESCRIPTION

In an embodiment of the focusing method of this invention, a focus lens of an image capturing device is moved from its current position in one selected direction, e.g. towards a near end (or a far end), and a contrast value corresponding to each position is produced in sequence. If the produced contrast values exhibit a rising trend, the focus lens will be continually moved towards the same direction (i.e. the resolution is increasing, and the focus lens is approaching an optimal position). If the produced contrast values are in decline (i.e. the resolution is decreasing, and the focus lens is moving away from the optimal position), the focus lens will be moved in a reverse direction instead, for example, switching from toward the near end to toward the far end. In this manner, the optimal position corresponding to a maximal contrast value (usually a peak value) can be found. In this embodiment, when the image capturing device starts focusing, the current position of the focus lens is taken as its initial position. An advantage of such approach is that the optimal position of the focus lens can be found quickly if the focus lens is not away from its current position, thereby reducing the time needed for focusing. In another embodiment, a number of times of direction reversal of the focus lens is limited to a predetermined value (e.g. one) to prevent from excessively long focusing time.

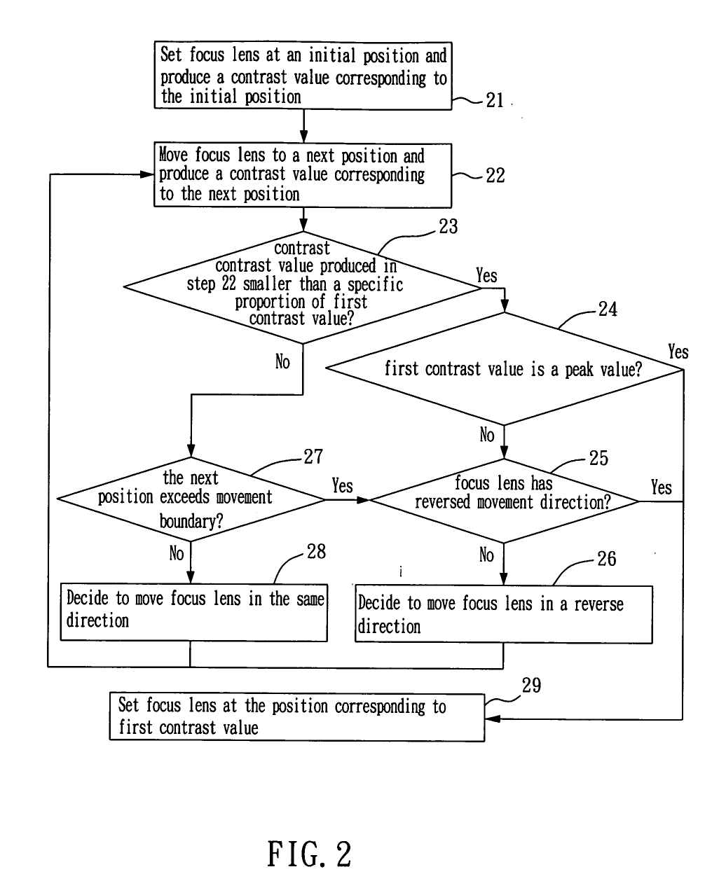

FIG. 2 is a flow chart of a preferred embodiment of the focusing method of this invention. This preferred embodiment is applicable to an image capturing device, such as a digital camera or digital camcorder. The image capturing device comprises a zoom lens, which contains a focus lens moved back and forth within a movement boundary during focusing. The movement distance of the focus lens is represented by one number of steps. The movement boundary can be used to avoid unnecessary movement range, and the manner for determining the movement boundary will be described below. In this preferred embodiment, the focus lens is allowed to reverse its movement direction once. As shown in FIG. 2, the flow includes the following steps:

Step 21: Set the focus lens at an initial position and produce a contrast value corresponding to the initial position;

Step 22: Move the focus lens to a next position and produce a contrast value corresponding to the next position;

Step 23: Determine whether the contrast value produced in step 22 is smaller than a specific proportion of a first contrast value; if not, jump to step 27, otherwise, proceed to step 24, wherein the first contrast value is a maximum among the contrast values already produced;

Step 24: Determine whether the first contrast value is a peak value; if yes, jump to step 29, otherwise, proceed to step 25;

Step 25: Determine whether the focus lens has reversed its movement direction; if yes, jump to step 29, otherwise, proceed to step 26;

Step 26: Decide to move the focus lens in a reverse direction and return to step 22;

Step 27: Determine whether the next position exceeds the movement boundary of the focus lens; if yes, jump to step 25, otherwise, proceed to step 28;

Step 28: Decide to move the focus lens in the same direction and return to step 22; and

Step 29: Set the focus lens at the position corresponding to the first contrast value.

In step 21, the initial position is set as the current position of the focus lens to save focusing time.

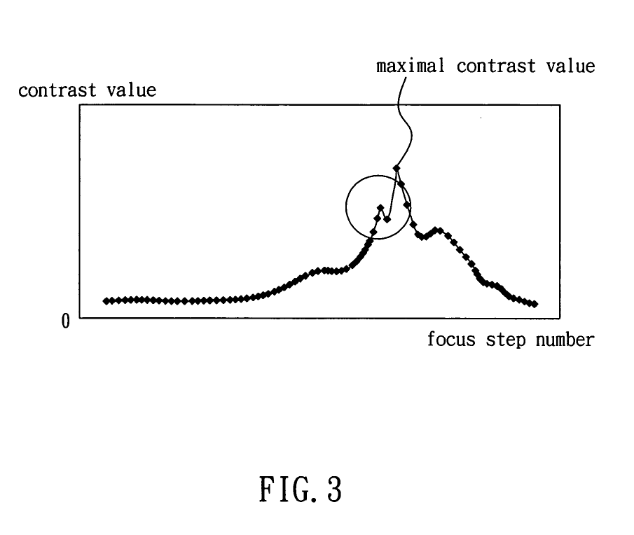

The determination in step 23 provides the basis to decide whether to reverse the movement direction of the focus lens. Since the first contrast value is the maximum among the contrast values already produced, if the contrast value produced in step 22 is smaller than the specific proportion of the first contrast value, it means the focus lens is moving away from the optimal position. Generally, as the focus lens moves towards one fixed direction, the contrast value would increase progressively (i.e. approaches the optimal position) or decrease progressively (i.e. moves away from the optimal position). But under certain circumstances, such as low environment luminance which increases noise signals to the light sensor, the contrast value might fluctuate and fails to maintain a pattern of increment or decrement, as shown in FIG. 3. Thus, this situation needs to be taken into consideration when the specific proportion is selected (e.g. choosing a smaller proportion), thereby preventing from misjudging a non-maximum peak value (e.g. the circle part in FIG. 3) as the optimal position of the focus lens. In an embodiment, the specific proportion is determined according to environment luminance and a zoom step of the image capturing device. Because the contrast value is influenced by both the environment luminance and the zoom step, the specific proportion can be properly determined by observing the variation of contrast values under different environment luminances and zoom steps.

In step 23, if the contrast value produced in step 22 is not smaller than the specific proportion of the first contrast value, it means the focus lens is currently moving in the right direction. So the flow jumps to step 27 to check whether the focus lens has exceeded its movement boundary. If not, it can continue to move in the same direction (i.e. step 28); if yes, the flow jumps to step 25 to check whether the focus lens has reversed its movement direction. If the focus lens has not reversed its direction, it is decided to reverse its direction (i.e. step 26); if it has, since the focus lens has exceeded the movement boundary and is not allowed to reverse its movement direction, step 29 is executed to set the position corresponding to the first contrast value as the optimal position for the focus lens. On the other hand, if the contrast value in step 22 is smaller than the specific proportion of the first contrast value, it means the focus lens is not moving in the right direction. Thus, the flow proceeds to step 24 to check whether the first contrast value is the peak value. If it is, it means the first contrast value is the maximal one corresponding to the optimal position (i.e. no greater contrast values can be produced in the ensuing steps), and then step 29 is executed; if not, the flow proceeds to step 25 to check whether the focus lens has ever changed its movement direction. If not, the focus lens is allowed to reverse its movement direction (step 26); if yes, since the current movement direction is inaccurate and the focus lens cannot reverse its direction, step 29 is executed to set the position corresponding to the first contrast value as the optimal position for the focus lens.

In an embodiment, the movement boundary of the focus lens is determined according to a zoom step of the image capturing device. In a preferred embodiment, two optimal focus step numbers respectively corresponding to focusing at the far end and the near end under the zoom step of the image capturing device are obtained as the movement boundary corresponding to the zoom step. That is, the focus lens is allowed to move between the positions corresponding to the two optimal focus step numbers.

In another embodiment in FIG. 2 (i.e. steps 21˜29, called first focusing procedure hereunder) is mixed with any known focusing method (called second focusing procedure) to perform focusing. In this manner, a proper focusing procedure that suits environment conditions at the time of focusing can be selected. The second focusing procedure can be a conventional focusing method, e.g. finding the position of the focus lens with a maximal contrast value by first moving the focus lens to the position corresponding to focusing at infinity, then moving stepwise towards the position corresponding to focusing at a near end, and computing a corresponding contrast value for each position during the movement. In this embodiment, when a decision condition is satisfied, the first focusing procedure will be executed; if not satisfied, the second focusing procedure will be executed. In a preferred embodiment, the decision condition is that the environment luminance is greater than a default luminance. As described above concerning FIG. 3, low environment luminance during focusing will increase the noise signals detected by the light sensor such that when the focus lens moves in one fixed direction, the contrast values fail to maintain a pattern of increment or decrement and instead exhibit small volatility as shown by the circle part in FIG. 3. Thus, when the environment luminance is not greater than the default luminance, in order to prevent from misjudging a non-maximum peak value as the maximal contrast value, we can set a smaller specific proportion in step 23, or as shown in this preferred embodiment, execute the second focusing procedure to avoid misjudgment since the contrast value corresponding to each possible position of the focus lens is computed.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A focusing method for an image capturing device having a focus lens, comprising steps of:
(a) setting the focus lens at an initial position and producing a contrast value corresponding to said initial position;
(b) moving the focus lens to a next position;
(c) producing a contrast value corresponding to said next position;
(d) determining to move the focus lens either in a same direction as step (b) or in a reverse direction according to the contrast values already produced;
(e) repeating steps (b) to (d) to produce a maximal contrast value; and
(f) setting the focus lens at a position corresponding to the maximal contrast value.

2. The focusing method according to claim 1, wherein said initial position is a current position of the focus lens.

3. The focusing method according to claim 1, wherein step (d) comprises:
comparing the contrast value produced in step (c) with a specific proportion of a first contrast value among the contrast values already produced.

4. The focusing method according to claim 3, wherein said first contrast value is a maximum of the contrast values already produced.

5. The focusing method according to claim 3, wherein said specific proportion is determined according to at least one of the following: a zoom step of the image capturing device and an environment luminance.

6. The focusing method according to claim 3, wherein in step (d), when the contrast value in step (c) is smaller than the specific proportion of the first contrast value, step (f) is executed if the first contrast value is a peak value.

7. The focusing method according to claim 3, wherein in step (d), when the contrast value in step (c) is smaller than the specific proportion of the first contrast value, the focus lens is determined to move in the reverse direction if the first contrast value is not a peak value.

8. The focusing method according to claim 3, wherein in step (d), when the contrast value in step (c) is smaller than the specific proportion of the first contrast value, the focus lens is determined to move in the reverse direction if the first contrast value is not a peak value and if the focus lens has not yet reversed its movement direction.

9. The focusing method according to claim 3, wherein in step (d), when the contrast value in step (c) is smaller than the specific proportion of the first contrast value, step (f) is executed if the first contrast value is not a peak value and the focus lens has reversed its movement direction.

10. The focusing method according to claim 3, wherein in step (d), when the contrast value in step (c) is not smaller than the specific proportion of the first contrast value, the focus lens is determined to move in the same direction as step (b).

11. The focusing method according to claim 3, wherein in step (d), when the contrast value in step (c) is not smaller than the specific proportion of the first contrast value, the focus lens is determined to move in the same direction as step (b) if the next position in step (c) does not exceed a movement boundary of the focus lens.

12. The focusing method according to claim 11, wherein in step (d), when the contrast value in step (c) is not smaller than the specific proportion of the first contrast value, the focus lens is determined to move in the reverse direction if the next position in step (c) exceeds said movement boundary and if the focus lens has not yet reversed its movement direction.

13. The focusing method according to claim 11, wherein in step (d), if the contrast value in step (c) is not smaller than the specific proportion of the first contrast value and the next position in step (c) exceeds said movement boundary and the focus lens has reversed its movement direction, step (f) is executed.

14. The focusing method according to claim 1, wherein said focus lens has a movement boundary.

15. The focusing method according to claim 14, wherein said movement boundary is determined according to a zoom step of said image capturing device.

16. The focusing method according to claim 15, wherein said movement boundary is determined according to two focus step numbers respectively corresponding to when the image capturing device focuses at a far end and a near end under said zoom step.

17. The focusing method according to claim 1, wherein a number of times of direction reversal of the focus lens is limited to a predetermined value.

18. The focusing method according to claim 17, wherein the predetermined value is one.

19. A mixed focusing method for an image capturing device having a focus lens, comprising steps of:
performing a first focusing procedure when a decision condition is satisfied; and
performing a second focusing procedure when said decision condition is not satisfied;
wherein said first focusing procedure comprises:
(a) setting the focus lens at an initial position and producing a contrast value corresponding to said initial position;
(b) moving the focus lens to a next position;
(c) producing a contrast value corresponding to said next position;
(d) determining to move the focus lens either in a same direction as step (b) or in a reverse direction according to the contrast values already produced;
(e) repeating steps (b) to (d) to produce a maximal contrast value; and
(f) setting the focus lens at a position corresponding to the maximal contrast value.

20. The mixed focusing method according to claim 19, wherein the decision condition is that an environment luminance is greater than a default luminance.
